(19) United States
(12) Patent Application Publication
(10) Pub. No.: US 2017/0061953 A1
(43) Pub. Date: Mar. 2, 2017

(54) ELECTRONIC DEVICE AND METHOD FOR CANCELLING NOISE USING PLURALITY OF MICROPHONES

(71) Applicant: Samsung Electronics Co., Ltd., Gyeonggi-do (KR)

(72) Inventors: Jung-Yeol AN, Seoul (KR); Jong-Mo KUM, Seoul (KR); Gang-Youl KIM, Gyeonggi-do (KR); Nam-II LEE, Gyeonggi-do (KR)

(73) Assignee: Samsung Electronics Co., Ltd.

(21) Appl. No.: 15/228,545

(22) Filed: Aug. 4, 2016

(30) Foreign Application Priority Data
Aug. 26, 2015 (KR) 10-2015-0120510

(51) Int. Cl. G10K 11/178; H04R 3/04; G06F 3/01; H04R 1/40

(52) U.S. Cl. CPC G10K 11/1786; H04R 1/406; H04R 3/04; G06F 3/013

(57) ABSTRACT

An electronic device for cancelling noise using a plurality of microphones is provided. The electronic device includes a plurality of microphones configured to obtain audio signals; a beamformer configured to provide, through a speaker, at least two audio signals selected on a basis of at least one of user information, external environment information, and information on an application executed the electronic device, among the obtained audio signals; and noise canceller configured to cancel at least some of the other audio signals determined on the basis of at least some of the selected audio signals, among the obtained audio signals.

### PRIORITY

This application claims priority under 35 U.S.C. §119(a) to Korean Patent Application Serial No. 10-2015-0120510, which was filed in the Korean Intellectual Property Office on Aug. 26, 2015, the entire content of which is incorporated herein by reference.

### BACKGROUND

1. Field of the Disclosure

The present disclosure relates generally to an electronic device, and more specifically, to an electronic device and method for cancelling noise using a plurality of microphones.

2. Description of the Related Art

In recent years, various types of electronic devices used in the real life have been modernized. In particular, with rapid growth of the smartphone market, various types of electronic devices used in the everyday life are released while a part or the entirety of functions of the smartphone are added thereto.

In particular, an earphone or a headphone for outputting, to ears of a user, a multimedia stored in the smartphone or a telephone tone through the smartphone has been used together with the smartphone.

Since such an earphone or a headphone outputs sounds while being pressed on and attached to ears of a user, a part of sounds outside the earphone or the headphone may enter the ears, and the other part thereof may not pass.

Accordingly, an earphone is being used to which a technology of blocking surrounding noise using an in-ear earphone for preventing a part of the outside sounds from entering ears, an earphone in a form of enhancing sealing by a periphery of a seating part inserted into ears of the user, the periphery being made of rubber, and an Active Noise Cancellation (ANC) method are applied.

As described above, an apparatus for cancelling noise according to the related art uses an ANC technology which blocks a path between ears of a user and the outside or blocks all external sounds.

However, when the user walks or moves on a road, it is difficult for the user to recognize a surrounding situation due to such an excessive shielding function, and thus, problems may occur in which the user faces danger, and sounds which the user needs, such as a horn sound of a vehicle notifying of an emergency situation, a station guidance sound, a sound calling the user from the surroundings, and the like, are considered to be noise, and are thus canceled.

Further, although an earphone having a ventilation hole formed therein to cause the sounds required by the user to reach the inside of the ears of the user has been developed, there is a problem in that the ventilation hole causes unnecessary noises and as well as necessary sounds among external sounds to enter the ears of the user.

An electronic device and a control method therefor may selectively provide some sounds of the external sounds to the user on the basis of user information or external environment information. Accordingly, the electronic device may provide, to the user, the sounds which the user needs, and may not provide, to the user, sounds which the user does not need.

### SUMMARY

According to an aspect of the present disclosure, an electronic device for cancelling noise using a plurality of microphones is provided. The electronic device includes a plurality of microphones configured to obtain audio signals; a beamformer configured to provide, through a speaker, at least two audio signals selected on a basis of at least one of user information, external environment information, and information on an application executed the electronic device, among the obtained audio signals; and a noise canceller configured to cancel at least some of the other audio signals determined on the basis of at least some of the selected audio signals, among the obtained audio signals.

According to another aspect of the present disclosure, obtaining audio signals; providing, to a speaker, at least two audio signals, selected on a basis of at least one piece of information of user information, external environment information, and information on an executed application, among the obtained audio signals; and cancelling at least one of the other audio signals determined on the basis of at least some of the selected audio signals among the obtained audio signals.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a diagram illustrating an environment in which a plurality of electronic devices are used according to embodiments of the present disclosure;

FIG. 2 is a block diagram illustrating an electronic device according to embodiments of the present disclosure;

FIG. 3 is a block diagram illustrating a program module according to embodiments of the present disclosure;

FIG. 4 is a flowchart illustrating a method of cancelling noise according to embodiments of the present disclosure;

FIGS. 5A to 5E are diagrams illustrating use environments of an electronic device for cancelling noise according to embodiments of the present disclosure;

FIGS. 6A and 6B are block diagrams illustrating an electronic device according to embodiments of the present disclosure;

FIGS. 7A to 7C are diagrams illustrating an example of a method of cancelling noise according to embodiments of the present disclosure;

FIGS. 8A to 8C are diagrams illustrating another example of a method of cancelling noise according to embodiments of the present disclosure;

FIGS. 9A and 9B are diagrams illustrating another example of a method of cancelling noise according to embodiments of the present disclosure; and

FIG. 10 illustrates yet another example of a method of cancelling noise according to embodiments of the present disclosure.

### DETAILED DESCRIPTION OF EMBODIMENTS OF THE PRESENT DISCLOSURE

Hereinafter, embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In the description of the drawings, similar reference numerals may be used to designate similar elements.

As used herein, the expressions “have”, “may have”, “include”, or “may include” refer to the existence of a corresponding feature (e.g., numeral, function, operation, or constituent element such as component), and do not exclude one or more additional features.

In the present disclosure, the expressions “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expressions “a first”, “a second”, “the first”, or “the second” used in embodiments of the present disclosure may modify various components regardless of the order and/or the importance but does not limit the corresponding components. For example, a first user device and a second user device indicate different user devices although both of them are user devices. For example, a first element may be referred to as a second element, and similarly, a second element may be referred to as a first element without departing from the scope of the present disclosure.

When it is mentioned that one element (e.g., a first element) is “(operatively or communicatively) coupled with/to or connected to” another element (e.g., a second element), it should be construed that the one element is directly connected to the another element or the one element is indirectly connected to the another element via yet another element (e.g., a third element). In contrast, it may be understood that when an element (e.g., first element) is referred to as being “directly connected,” or “directly coupled” to another element (second element), there are no element (e.g., third element) interposed between them.

The expression “configured to” used in the present disclosure may be used interchangeably with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g., embedded processor) only for performing the corresponding operations or a generic-purpose processor (e.g., central processing unit (CPU) or application processor (AP)) that can perform the corresponding operations by executing one or more software programs stored in a memory device.

The terms used herein are merely for the purpose of describing particular embodiments and are not intended to limit the scope of other embodiments of the present disclosure. As used herein, singular forms may include plural forms as well unless the context clearly indicates otherwise. Unless defined otherwise, all terms used herein, including technical and scientific terms, have the same definitions as those commonly understood by a person skilled in the art to which the present disclosure pertains. Such terms as those defined in a generally used dictionary may be interpreted to have the definitions equivalent to the contextual definitions in the relevant field of art, and are not to be interpreted to have ideal or excessively formal definitions unless clearly defined in the present disclosure. In some cases, terms defined in this specification may not be interpreted as excluding embodiments of the present disclosure.

An electronic device according to embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device. According to embodiments of the present disclosure, the wearable device may include at least one of an accessory type (e.g., a watch, a ring, a bracelet, an anklet, a necklace, a glasses, a contact lens, or a Head-Mounted Device (HMD)), a fabric or clothing integrated type (e.g., an electronic clothing), a body-mounted type (e.g., a skin pad, or tattoo), and a bio-implantable type (e.g., an implantable circuit).

According to some embodiments of the present disclosure, the electronic device may be a home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

According to another embodiment of the present disclosure, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller machine (ATM) in banks, point of sales (POS) device in a shop, or an Internet of Things (IoT) device (e.g., a light bulb, various sensors, electric or gas meter, a sprinkler device, a fire alarm, a thermostat, a streetlamp, a toaster, a sporting goods, a hot water tank, a heater, a boiler, etc.).

According to some embodiments of the present disclosure, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device may be a combination of one or more of the aforementioned various devices. The electronic device may also be a flexible device. Further, the electronic device is not limited to the aforementioned devices, and may include a new electronic device according to the development of technology

Hereinafter, an electronic device according to embodiments will be described with reference to the accompanying drawings. In the present disclosure, the term “user” may indicate a person using an electronic device or a device (e.g., an artificial intelligence electronic device) using an electronic device.

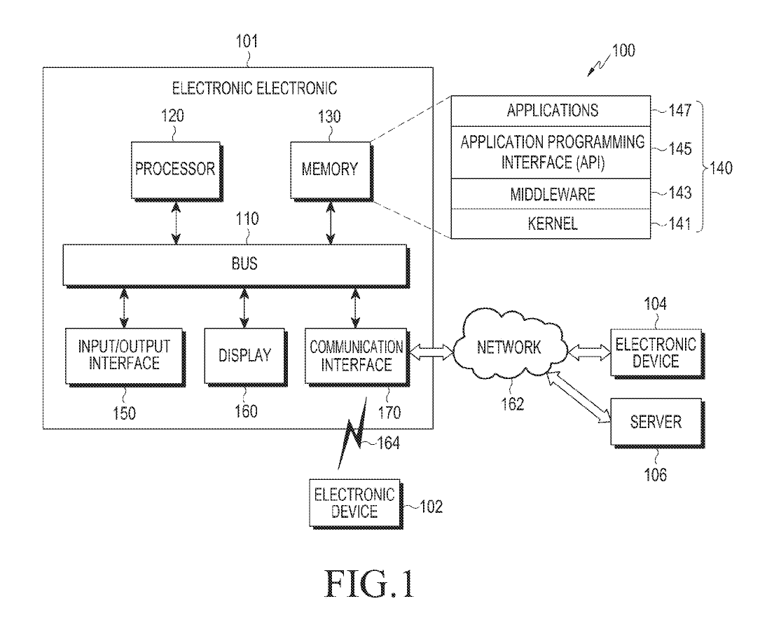

Referring to FIG. 1, an electronic device 101 within a network environment 100 according to embodiments is illustrated. The electronic device 101 may include a bus 110, a processor 120, a memory 130, an input/output interface 150, a display 160, and a communication circuit 170. The electronic device 101 may omit at least one of the elements or may further include other elements.

The bus 110 may include, for example, a circuit for connecting elements 110 to 170 to each other and transferring communication (for example, control messages and/or data) between the elements.

The processor 120 may include one or more of a Central Processing Unit (CPU), an Application Processor (AP), and a Communication Processor (CP). For example, the processor 120 can carry out operations or data processing relating to control and/or communication of at least one other element of the electronic device 101.

The memory 130 may include a volatile memory and/or a non-volatile memory. The memory 130 can store, for example, instructions or data related to at least one other element of the electronic device 101. According to an embodiment of the present disclosure, the memory 130 can store software and/or a program 140. The program 140 may include, for example, a kernel 141, a middleware 143, an Application Programming Interface (API) 145, and/or application programs (or “applications”) 147. At least some of the kernel 141, the middleware 143, and the API 145 may be referred to as an Operating System (OS).

In the present document, the application may be referred to as an app.

The kernel 141 can, for example, control or manage system resources (for example, the bus 110, the processor 120, or the memory 130) used for performing an operation or function implemented by the other programs (for example, the middleware 143, the API 145, or the application programs 147). Further, the kernel 141 can provide an interface through which the middleware 143, the API 145, or the application programs 147 can access the individual elements of the electronic device 101 to control or manage the system resources.

The middleware 143 can, for example, function as an intermediary for allowing the API 145 or the application programs 147 to communicate with the kernel 141 to exchange data.

Further, the middleware 143 can process one or more task requests received from the application program 147 according to priorities thereof. For example, the middleware 143 can assign priorities for using the system resources (for example, the bus 110, the processor 120, the memory 130, or the like) of the electronic device 101, to at least one of the application programs 147. For example, the middleware 143 can perform scheduling or load balancing on the one or more task requests by processing the one or more task requests according to the priorities assigned thereto.

The API 145 is an interface through which the applications 147 control functions provided from the kernel 141 or the middleware 143, and may include, for example, at least one interface or function (for example, instruction) for file control, window control, image processing, or text control.

The input/output interface 150 may function as, for example, an interface that can transfer instructions or data input by a user or another external device to the other element(s) of the electronic device 101. Further, the input/output interface 150 can output the instructions or data received from the other element(s) of the electronic device 101 to the user or another external device.

Examples of the display 160 may include a Liquid Crystal Display (LCD), a Light-Emitting Diode (LED) display, an Organic Light-Emitting Diode (OLED) display, a MicroElectroMechanical Systems (MEMS) display, and an electronic paper display. The display 160 may display, for example, various types of contents (for example, text, images, videos, icons, or symbols) for the user. The display 160 may include a touch screen, and can receive, for example, a touch, a gesture, proximity, or hovering input by using an electronic pen or the user's body part.

In accordance with embodiments of the present disclosure, the display 160 may be used as having the same definition as that of a touch screen.

The communication interface 170 can set communication between, for example, the electronic device 101 and an external device (for example, a first external electronic device 102, a second external electronic device 104, or a server 106). For example, the communication interface 170 may be connected to a network 162 through wireless or wired communication so as to communicate with the external device (for example, the second external electronic device 104 or the server 106).

The wireless communication may use at least one of, for example, Long Term Evolution (LTE), LTE-Advance (LTE-A), Code Division Multiple Access (CDMA), Wideband CDMA (WCDMA), Universal Mobile Telecommunications System (UMTS), WiBro (Wireless Broadband), and Global System for Mobile Communications (GSM), as a cellular communication protocol. In addition, the wireless communication may include, for example, short range communication 164. The short-range communication 164 may include at least one of, for example, Wi-Fi, Bluetooth, Near Field Communication (NFC), and Global Navigation Satellite System (GNSS). The GNSS may include at least one of, for example, a Global Positioning System (GPS), a Global Navigation Satellite System (Glonass), a Beidou Navigation Satellite System (Beidou), and a European Global Satellite-based Navigation System (Galileo), according to a use area, a bandwidth, or the like. Hereinafter, in the present document, the “GPS” may be interchangeably used with the “GNSS”. The wired communication may include at least one of, for example, a Universal Serial Bus (USB), a High Definition Multimedia Interface (HDMI), Recommended Standard 232 (RS-232), and a Plain Old Telephone Service (POTS). The network 162 may include at least one of a communication network, e.g., a computer network (e.g., a LAN or a WAN), the Internet, and a telephone network.

Each of the first and second external electronic devices 102 and 104 may be a device which is the same as or different from the electronic device 101. According to an embodiment of the present disclosure, the server 106 may include a group of one or more servers. All or some of the operations performed in the electronic device 101 may be performed in another electronic device or a plurality of electronic devices (for example, the electronic devices 102 and 104 or the server 106). When the electronic device 101 has to perform some functions or services automatically or in response to a request, the electronic device 101 can make a request for performing at least some functions relating thereto to another device (for example, the electronic device 102 or 104 or the server 106) instead of performing the functions or services by itself or in addition. Another electronic device (for example, the electronic device 102 or 104, or the server 106) can execute the requested functions or the additional functions, and can deliver a result of the execution to the electronic device 101. The electronic device 101 can process the received result as it is or additionally to provide the requested functions or services. To achieve this, for example, cloud computing, distributed computing, or client-server computing technology may be used.

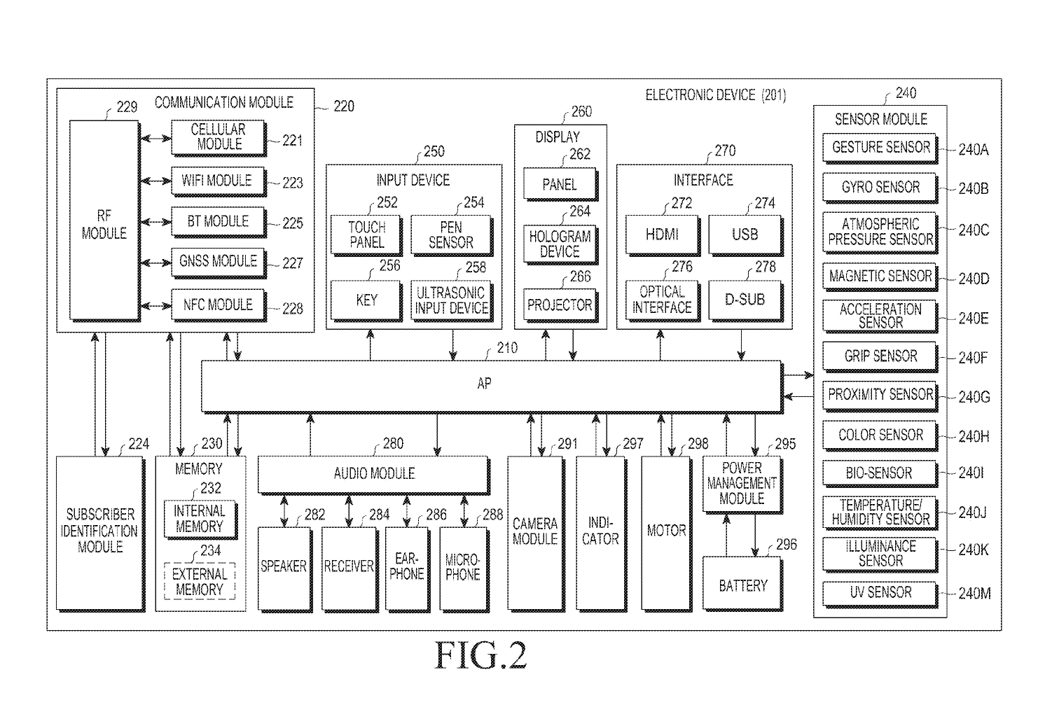

FIG. 2 is a block diagram illustrating an electronic device 201 according to embodiments of the present disclosure. The electronic device 201 may include, for example, the whole or part of the electronic device 101 illustrated in FIG. 1. The electronic device 201 may include at least one Application Processor (AP) 210, a communication module 220, a Subscriber Identification Module (SIM) card 224, a memory 230, a sensor module 240, an input device 250, a display 260, an interface 270, an audio module 280, a camera module 291, a power management module 295, a battery 296, an indicator 297, and a motor 298.

The processor 210 can control a plurality of hardware or software components connected to the processor 210 by driving an operating system or an application program and perform processing of various pieces of data and calculations. The processor 210 may be implemented by, for example, a System on Chip (SoC). According to an embodiment of the present disclosure, the processor 210 may further include a Graphic Processing Unit (GPU) and/or an image signal processor. The processor 210 may include at least some (for example, a cellular module 221) of the elements illustrated in FIG. 2. The processor 210 can load, into a volatile memory, instructions or data received from at least one of the other elements (for example, a non-volatile memory) and may process the loaded instructions or data, and can store various data in a non-volatile memory.

The communication module 220 may have a configuration equal or similar to that of the communication interface 170 of FIG. 1. The communication module 220 may include, for example, a cellular module 221, a Wi-Fi module 223, a Bluetooth module 225, a GNSS module 227 (e.g., a GPS module, a Glonass module, a Beidou module, or a Galileo module), an NFC module 228, and a Radio Frequency (RF) module 229.

The cellular module 221 can provide a voice call, an image call, a text message service, an Internet service, or the like through, for example, a communication network. The cellular module 221 can identify and authenticate the electronic device 201 within a communication network using a subscriber identification module (for example, the SIM card 224). The cellular module 221 can perform at least some of functions that the processor 210 can provide. The cellular module 221 may include a Communication Processor (CP).

The Wi-Fi module 223, the Bluetooth module 225, the GNSS module 227, or the NFC module 228 may include, for example, a processor for processing data transmitted and received through the corresponding module. According to some embodiments of the present disclosure, at least some (two or more) of the cellular module 221, the Wi-Fi module 223, the Bluetooth module 225, the GNSS module 227, and the NFC module 228 may be included in one Integrated Chip (IC) or IC package.

The RF module 229 can transmit and receive, for example, a communication signal (for example, an RF signal). The RF module 229 may include, for example, a transceiver, a Power Amplifier Module (PAM), a frequency filter, a Low Noise Amplifier (LNA), and an antenna. According to another embodiment of the present disclosure, at least one of the cellular module 221, the Wi-Fi module 223, the BT module 225, the GPS module 227, and the NFC module 228 can transmit/receive an RF signal through a separate RF module.

The subscriber identification module 224 may include, for example, a card including an embedded SIM, and may contain unique identification information (e.g., an Integrated Circuit Card Identifier (ICCID)) or subscriber information (e.g., an International Mobile Subscriber Identity (IMSI)).

The memory 230 (e.g., the memory 130) may include, for example, an internal memory 232 or an external memory 234. The internal memory 232 may include at least one of, for example, a volatile memory (for example, a Dynamic Random Access Memory (DRAM), a Static RAM (SRAM), a Synchronous Dynamic RAM (SDRAM), and the like) and a non-volatile memory (for example, a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a flash memory (e.g., a NAND flash memory or a NOR flash memory), a hard disk drive, a Solid State Drive (SSD), and the like).

The external memory 234 may further include a flash drive, for example, a Compact Flash (CF), a Secure Digital (SD), a Micro Secure Digital (Micro-SD), a Mini Secure Digital (Mini-SD), an eXtreme Digital (xD), a MultiMedia Card (MMC), a memory stick, or the like. The external memory 234 may be functionally and/or physically connected to the electronic device 201 through various interfaces.

The sensor module 240 can, for example, measure a physical quantity or detect an operation state of the electronic device 201 so as to convert the measured or detected information into an electrical signal. The sensor module 240 may include at least one of, for example, a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (for example, a red, green, blue (RGB) sensor), a biometric sensor 240I, a temperature/humidity sensor 240J, an illuminance sensor 240K, and a ultraviolet (UV) sensor 240M. Additionally or alternatively, the sensor module 240 may include, for example, an E-nose sensor, an ElectroMyoGraphy (EMG) sensor, an ElectroEncephaloGram (EEG) sensor, an ElectroCardioGram (ECG) sensor, an Infrared (IR) sensor, an iris sensor, and/or a fingerprint sensor. The sensor module 240 may further include a control circuit for controlling one or more sensors included therein. In some embodiments of the present disclosure, the electronic device 201 may further include a processor configured to control the sensor module 240 as a part of or separately from the processor 210, and can control the sensor module 240 while the processor 210 is in a sleep state.

The input device 250 may include, for example, a touch panel 252, a (digital) pen sensor 254, a key 256, and an ultrasonic input unit 258. The touch panel 252 can use at least one of, for example, a capacitive type, a resistive type, an infrared type, and an ultrasonic type. Also, the touch panel 252 may further include a control circuit. The touch panel 252 may further include a tactile layer, and can provide a tactile reaction to the user.

The (digital) pen sensor 254 may include, for example, a recognition sheet which is a part of the touch panel or is separated from the touch panel. The key 256 may include, for example, a physical button, an optical key or a keypad. The ultrasonic input device 258 can detect ultrasonic waves generated by an input tool through a microphone 288, and identify data corresponding to the detected ultrasonic waves.

The display 260 (e.g., the display 160) may include a panel 262, a hologram device 264 or a projector 266. The panel 262 may include a configuration that is identical or similar to that of the display 160 illustrated in FIG. 1. The panel 262 may be implemented to be, for example, flexible, transparent, or wearable. The panel 262 and the touch panel 252 may be configured as one module. The hologram 264 can show a three dimensional image in the air by using an interference of light. The projector 266 may display an image by projecting light onto a screen. The screen may be located, for example, inside or outside the electronic device 201. According to an embodiment of the present disclosure, the display 260 may further include a control circuit for controlling the panel 262, the hologram device 264, or the projector 266.

In accordance with embodiments of the present disclosure, the display 160 including the panel 262 may be used as having the same definition as that of a touch screen. That is, the touch screen may be defined as a definition including the display 160 for displaying particular information and the panel 262 which can receive a touch input.

The interface 270 may include, for example, a High-Definition Multimedia Interface (HDMI) 272, a Universal Serial Bus (USB) 274, an optical interface 276, or a D-subminiature (D-sub) 278. The interface 270 may be included in, for example, the communication interface 170 illustrated in FIG. 1. Additionally or alternatively, the interface 270 may include, for example, a Mobile High-definition Link (MHL) interface, a Secure Digital (SD) card/Multi-Media Card (MMC) interface, or an Infrared Data Association (IrDA) standard interface.

The audio module 280 can, for example, bilaterally convert a sound and an electrical signal. At least some elements of the audio module 280 may be included in, for example, the input/output interface 145 illustrated in FIG. 1. The audio module 280 can, for example, process sound information which is input or output through a speaker 282, a receiver 284, earphones 286, the microphone 288, and the like.

The camera module 291 is a device which can photograph a still image and a dynamic image. According to an embodiment of the present disclosure, the camera module 291 may include one or more image sensors (for example, a front sensor or a rear sensor), a lens, an Image Signal Processor (ISP) or a flash (for example, a LED or a xenon lamp).

The power management module 295 can, for example, manage power of the electronic device 201. According to an embodiment of the present disclosure, the power management module 295 may include a Power Management Integrated Circuit (PMIC), a charger Integrated Circuit (IC), or a battery gauge. The PMIC may use a wired and/or wireless charging method. Examples of the wireless charging method may include, for example, a magnetic resonance method, a magnetic induction method, an electromagnetic method, and the like. Additional circuits, e.g., a coil loop, a resonance circuit, a rectifier, and the like, for wireless charging may be further included. The battery gauge can, for example, measure a residual quantity of the battery 296, and a voltage, a current, or a temperature during the charging. The battery 296 may include, for example, a rechargeable battery and/or a solar battery.

The indicator 297 can display a particular state (for example, a booting state, a message state, a charging state, or the like) of the electronic device 201 or a part (for example, the processor 210) of the electronic device 201. The motor 298 can convert an electrical signal into mechanical vibrations, and can generate a vibration or haptic effect. Although not illustrated, the electronic device 201 may include a processing device (for example, a GPU) for supporting a mobile TV. The processing unit for supporting a mobile TV can, for example, process media data according to a certain standard such as Digital Multimedia Broadcasting (DMB), Digital Video Broadcasting (DVB), or mediaFlo™.

Each of the above-described component elements of hardware according to the present disclosure may be configured with one or more components, and the names of the corresponding component elements may vary based on the type of electronic device. The electronic device may include at least one of the aforementioned elements. Some elements may be omitted or other additional elements may be further included in the electronic device. Also, some of the hardware components may be combined into one entity, which may perform functions identical to those of the relevant components before the combination.

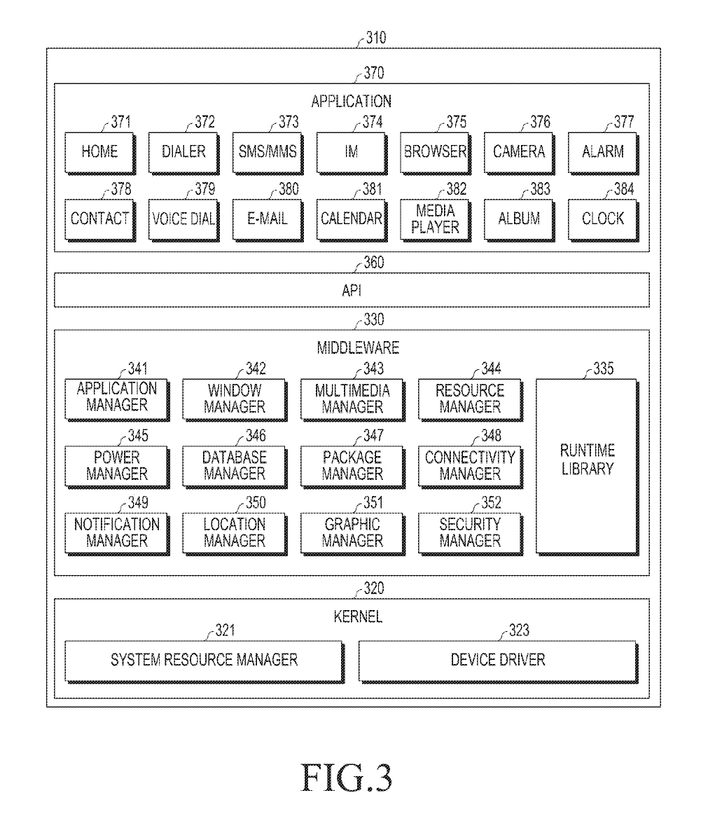

FIG. 3 is a block diagram illustrating a program module according to embodiments of the present disclosure. The program module 310 (e.g., the program 140) may include an Operating System (OS) for controlling resources related to the electronic device (for example, the electronic device 101) and/or various applications (for example, the application programs 147) executed in the operating system. The operating system may be, for example, Android, iOS, Windows, Symbian, Tizen, Bada, or the like.

The program module 310 may include a kernel 320, middleware 330, an Application Programming Interface (API) 360, and/or applications 370. At least some of the program module 310 may be preloaded on the electronic device, or may be downloaded from an external electronic device (for example, the electronic device 102 or 104, or the server 106).

The kernel 320 (for example, the kernel 141) may include, for example, a system resource manager 321 and/or a device driver 323. The system resource manager 321 can perform the control, allocation, retrieval, or the like of system resources. According to an embodiment of the present disclosure, the system resource manager 321 may include a process manager, a memory manager, a file system manager, or the like. The device driver 323 may include, for example, a display driver, a camera driver, a Bluetooth driver, a shared memory driver, a USB driver, a keypad driver, a Wi-Fi driver, an audio driver, or an Inter-Process Communication (IPC) driver.

The middleware 330 can, for example, provide a function commonly required by the applications 370, or provide various functions to the applications 370 through the API 360 so that the applications 370 can efficiently use limited system resources within the electronic device. According to an embodiment of the present disclosure, the middleware 330 (for example, the middleware 143) may include, for example, at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module which a compiler uses in order to add a new function through a programming language while the applications 370 are being executed. The runtime library 335 can perform input/output management, memory management, the functionality for an arithmetic function, or the like.

The application manager 341 can, for example, manage a life cycle of at least one of the applications 370. The window manager 342 can manage Graphical User Interface (GUI) resources used for the screen. The multimedia manager 343 can identify a format required to reproduce various media files, and can encode or decode a media file by using a COder/DECoder (CODEC) appropriate for the corresponding format. The resource manager 344 can manage resources, such as a source code, a memory, a storage space, and the like of at least one of the applications 370.

The power manager 345 can, for example, operate together with a Basic Input/Output System (BIOS) to manage a battery or power and provide power information required for the operation of the electronic device. The database manager 346 can generate, search for, and/or change a database to be used by at least one of the applications 370. The package manager 347 can manage the installation or update of an application distributed in the form of a package file.

The connectivity manager 348 can manage a wireless connection such as, for example, Wi-Fi or Bluetooth. The notification manager 349 can display or notify of an event, such as an arrival message, an appointment, a proximity notification, and the like, in such a manner as not to disturb the user. The location manager 350 can manage location information of the electronic device. The graphic manager 351 can manage a graphic effect, which is to be provided to the user, or a user interface related to the graphic effect. The security manager 352 can provide various security functions required for system security, user authentication, and the like. According to an embodiment of the present disclosure, when the electronic device (for example, the electronic device 101) has a telephone call function, the middleware 330 may further include a telephony manager for managing a voice call function or a video call function of the electronic device.

The middleware 330 may include a middleware module that forms a combination of various functions of the above-described elements. The middleware 330 may provide a module specialized for each type of OS in order to provide a differentiated function. Also, the middleware 330 can dynamically delete some of the existing elements, or add new elements.

For example, the API 360 (for example, the API 145), which is a set of API programming functions, may be provided with a different configuration according to an OS. For example, in the case of Android or iOS, one API set may be provided for each platform. In the case of Tizen, two or more API sets may be provided for each platform.

The applications 370 (for example, the application programs 147) may include a home application 371, a dialer 372, a Short Message Service (SMS)/Multimedia Messaging Service (MMS) 373, an Instant Message (IM) 374, a browser 375, a camera 376, an alarm 377, a contacts 378, a voice dialer 379, an e-mail 380, a calendar 381, a media player 382, an album 383, a clock 384, or one or more applications which can perform functions of health care (e.g., measure exercise quantity or blood sugar), or of providing environment information (for example, atmospheric pressure, humidity, or temperature information).

According to an embodiment of the present disclosure, the applications 370 may include an information exchange application supporting information exchange between the electronic device (for example, the electronic device 101) and an external electronic device (for example, the electronic device 102 or 104). The information exchange application may include, for example, a notification relay application for transferring specific information to an external electronic device or a device management application for managing an external electronic device.

For example, the notification relay application may include a function of transferring, to the external electronic device (for example, the electronic device 102 or 104), notification information generated by other applications of the electronic device 101 (for example, an SMS/MMS application, an e-mail application, a health management application, or an environmental information application). Further, the notification relay application can, for example, receive notification information from the external electronic device and provide the received notification information to a user.

The device management application can, for example, manage (for example, install, delete, or update) at least one function (for example, turning on/off the external electronic device itself (or some elements thereof) or adjusting brightness (or resolution) of a display) of the external electronic device (for example, the electronic device 102 or 104) communicating with the electronic device, applications executed in the external electronic device, or services (for example, a telephone call service or a message service) provided from the external electronic device.

According to an embodiment of the present disclosure, the applications 370 may include applications (for example, a health care application of a mobile medical appliance or the like) designated according to attributes of the external electronic device 102 or 104. The application 370 may include an application received from the external electronic device (for example, the server 106, or the electronic device 102 or 104). The application 370 may include a preloaded application or a third party application which can be downloaded from the server. Names of the elements of the program module 310 may change depending on the type of OS.

According to embodiments of the present disclosure, at least some of the program module 310 may be implemented in software, firmware, hardware, or a combination of two or more thereof. At least some of the program module 310 may be implemented (e.g., executed) by, for example, the processor (e.g., the processor 210). At least some of the program module 310 may include, for example, a module, a program, a routine, a set of instructions, and/or a process for performing one or more functions.

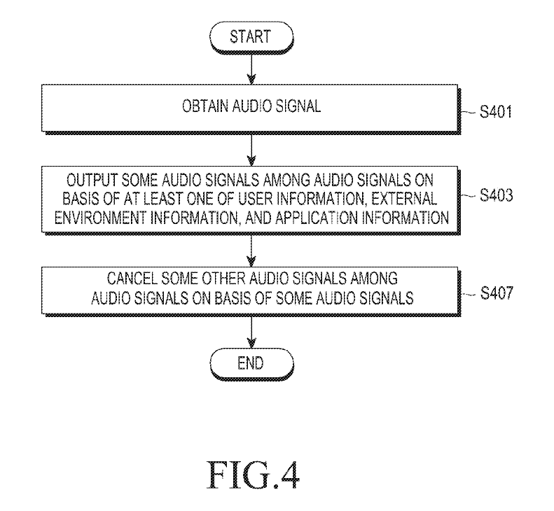

Hereinafter, a method of cancelling noise according to embodiments of the present disclosure will be described with reference to FIGS. 4 to 10.

FIG. 4 is a flowchart illustrating a method of cancelling noise according to embodiments of the present disclosure.

According to an embodiment of the present disclosure, in step S401, an electronic device (the electronic device 101, the electronic device 102, or the electronic device 210) cancels audio signals from the outside of the electronic device.

In step S403, when an external sound is received, the electronic device can output some audio signals among the audio signals on the basis of at least one piece of information of user information, external environment information, and application information obtained on the basis of a predetermined sound receiving condition.

According to an embodiment of the present disclosure, external audio signals may include noise and a signal according to the predetermined sound receiving condition. The electronic device can obtain at least one piece of information among the user information, the external environment information, and the application information on the basis of the predetermined sound receiving condition, and select a signal (some audio signals) according to the predetermined sound receiving condition among the external audio signals on the basis of the at least one obtained piece of information. When the signal (some audio signals) according to the predetermined sound receiving condition is selected, the electronic device can output the selected signal (some audio signals) according to the predetermined sound receiving condition.

According to an embodiment of the present disclosure, the electronic device can perform beamforming using a plurality of microphones (the microphone 288) included in the electronic device on the basis of the at least one piece of information of the user information, the external environment information and the application information obtained on the basis of the predetermined sound receiving condition, and output a signal (some audio signals) according to the at least one piece of information of the user information, the external environment information and the application information obtained on the basis of the predetermined sound receiving condition, among the external audio signals, using the beamforming.

The beamforming may include an operation of storing or outputting a first sound obtained in a predetermined direction or a predetermined region, among audio signals obtained by two or more microphones, and storing or blocking outputting of a second sound obtained in a direction different from the predetermined direction or in a region different from the predetermined region. The beamforming may, for example, include an operation of setting a direction or region in which the external audio signals are obtained using a plurality of microphones.

The sound receiving condition may be a condition for a sound or signal (hereinafter, necessary sound) to be output through the electronic device, among sounds received from the outside to the electronic device.

As an example of obtaining the sound receiving condition, according to an embodiment of the present disclosure, when external audio signals are obtained through an electronic device for cancelling noise, the electronic device for cancelling noise can obtain a pre-stored sound receiving condition from a memory.

As another example of obtaining the sound receiving condition, according to an embodiment of the present disclosure, when external audio signals are obtained through the electronic device for cancelling noise, the electronic device for cancelling noise can obtain a sound receiving condition based on an input through the input device.

As yet another example of obtaining a predetermined sound receiving condition, according to an embodiment of the present disclosure, when external audio signals are obtained through the electronic device (e.g., a headphone) for cancelling noise, the electronic device for cancelling noise can obtain a sound receiving condition from a smartphone, and select some audio signals from among audio signals on the basis of the obtained sound receiving condition.

The sound receiving condition may include user storage information stored in the memory. The user storage information may include information on the sound receiving condition pre-stored in a memory inside or outside the electronic device. For example, the user storage information may be previously input through the input device by a user and be stored in the memory, or may be received from an external device and be stored in the memory. For example, the user storage information may include a sound receiving condition indicating “to receive the largest received sound”. As an example of obtaining the user storage information, according to an embodiment of the present disclosure, when external audio signals are obtained, the electronic device can obtain the user storage information from a memory inside or outside the electronic device.

The sound receiving condition may include the user input information input through the input device. The user input information may include information according to an input received through an input device inside or outside the electronic device. For example, the user input information may be input through the input device by a user of the electronic device. For example, the user input information may include a sound receiving condition indicating “to adjust sensitivity according to a degree of fatigue”. As an example of obtaining the user input information, according to an embodiment of the present disclosure, when external audio signals are obtained, the electronic device can obtain the user input information from a memory inside or outside the electronic device.

The user information may include user health information, user gaze direction information, and user location information.

The user health information may include information on health of a user, which is obtained through a health information obtainer inside or outside the electronic device. For example, the information on health of a user may include information on a degree of fatigue, the blood pressure, or the number of heartbeats, which can be obtained through the health information obtainer. For example, the health information obtainer may be attached to the body of a user and can obtain biometric signal information from the body of the user while being attached to the body of the user. For example, the user health information may include information indicating that “a current degree of fatigue of a user increases” or “a current degree of fatigue of a user decreases”. As an example of obtaining the user health information, according to an embodiment of the present disclosure, when external audio signals are obtained, the electronic device can obtain a sound receiving condition (the user storage information or the user input information) through the memory or the input device, transmit a request signal for the user health information to the health information obtainer on the basis of the obtained sound receiving condition, acquire, for example, user health information of “a degree of fatigue of a user increases” in response to the request signal from the health information obtainer, and make a change to “increase” the sensitivity for a sound received in a predetermined direction or region of the beamforming on the basis of the obtained user health information of “a degree of fatigue of a user increases”.

The user gaze direction information may include information on a direction (e.g., 30 degrees) in which the gaze direction of the user faces and which is obtained through a gaze direction information obtainer inside or outside the electronic device. For example, the gaze direction information obtainer can obtain image information on eyes among a body of a user, and obtain the information on the direction in which the gaze direction of the user faces, on the basis of the image information on eyes. As an example of obtaining the user gaze direction information, according to an embodiment of the present disclosure, when external audio signals are obtained, the electronic device can obtain a sound receiving condition (the user storage information or the user input information) through the memory or the input device, transmit a request signal for the user health information to the gaze direction information obtainer on the basis of the obtained sound receiving condition, acquire, for example, user gaze direction information “the gaze direction of a user is in a direction of 30 degrees” in response to the request signal from the gaze direction information obtainer, and change a direction or region of the beamforming to “a direction of 30 degrees” or “a region of 30 degrees” on the basis of the obtained user gaze direction information “the gaze direction of a user is in a direction of 30 degrees”.

The user location information may include information on a location of a user (or the electronic device) obtained through a location information module (e.g., a Global Positioning System (GPS)) inside or outside the electronic device. For example, the location information module can obtain a GPS signal from the outside, and obtain information on a location of a user on the basis of the obtained GPS signal. As an example of obtaining the user location information, when external audio signals are obtained, the electronic device can obtain a sound receiving condition through the memory or the input device, transmit a request signal for location information of a user to the location information module on the basis of the obtained sound receiving condition, acquire, for example, location information of “the location of a user is 1, Jongno-gu, Seoul”, from the location information module in response to the request signal, and change a direction or region of the beamforming to a direction of “2, Jongno-gu, Seoul” adjacent to the location of “1, Jongno-gu, Seoul” on the basis of the location information of “1, Jongno-gu, Seoul”.

External environment information may include, for example, at least one piece of information among information on a sound receiving direction of a necessary signal within external sounds, information on a sound receiving sensitivity, information on the waveform of a sound receiving signal, and information on the size of a sound receiving signal, or at least one piece of information among information on a sound receiving size. For example, the information on the sound receiving direction may include information on a predetermined direction (e.g., a direction of 90 degrees) or a predetermined region (e.g., a region in the direction of 90 degrees) within audio signals received from the outside. For example, the information on the sound receiving sensitivity may include information on reception sensitivity until received external audio signals are received by a plurality of microphones. For example, the information on the waveform of a sound receiving signal may include information on a degree (e.g., a correlation factor) to which the waveform is similar to a predetermined first sound waveform obtained through a memory or an input device. For example, the information on the sound receiving size may include information on a relative sound receiving size (e.g., the size in a unit of decibels (dB)) when the external audio signals are received by the plurality of microphones. The electronic device can obtain at least one piece of information among the information on the sound receiving direction of the necessary signal, the information on the sound receiving sensitivity, and the information on the sound receiving size, through an external smartphone, an external environment information acquisition device (e.g., a plurality of microphones), a memory, or an input device functionally connected to the electronic device. As an example of obtaining the external environment information, according to an embodiment of the present disclosure, when external audio signals are obtained, the electronic device can obtain a sound receiving condition (user storage information or the user input information) through a memory or an input device, transmit a request signal for external environment information to a plurality of microphones (external environment information acquisition apparatus) on the basis of the obtained sound receiving condition, obtain external environment information indicating that “a signal coinciding with 90% or higher of a pre-stored first sound waveform is a sound in a direction of 30 degrees” from a plurality of microphones, and change a direction or a region of the beamforming to “a direction of 30 degrees” or “a region of 30 degrees” on the basis of the obtained external environment information of “a signal coinciding with 90% or higher of a sound in a direction of 30 degrees”.

The application information may include information on a content of an application (or a content reproduced by an application) executed by the electronic device. The electronic device can obtain the information on a content of an application through a processor within the electronic device or a processor of an external smartphone functionally connected to the electronic device. For example, when external audio signals are obtained, the electronic device can transmit a request signal for the application information to the external smartphone, obtain application information of “a content of a currently executed application is a video” by the processor of the smartphone in response to the request signal, and change a direction or a region of the beamforming to “a direction of 0 degrees” or “a region of 0 degrees” on the basis of the application information “a content of a currently executed application is a video”, for example, in order to obtain a sound in the front direction of a user more loudly.

In step S407, the electronic device can cancel some other audio signals from the external audio signals obtained by the electronic device on the basis of some of the pre-selected audio signals.

The external audio signals may include some of the pre-selected audio signals (necessary signals) which a user wants to hear and a signal (noise signal) which a user wants to remove.

As a result, while listening to a multimedia content or a phone call sound by an earphone provided in the electronic device, a user can block noise within external sounds, and for example, clearly hear a necessary sound according to a sound receiving condition input by a user in advance or stored in the memory.

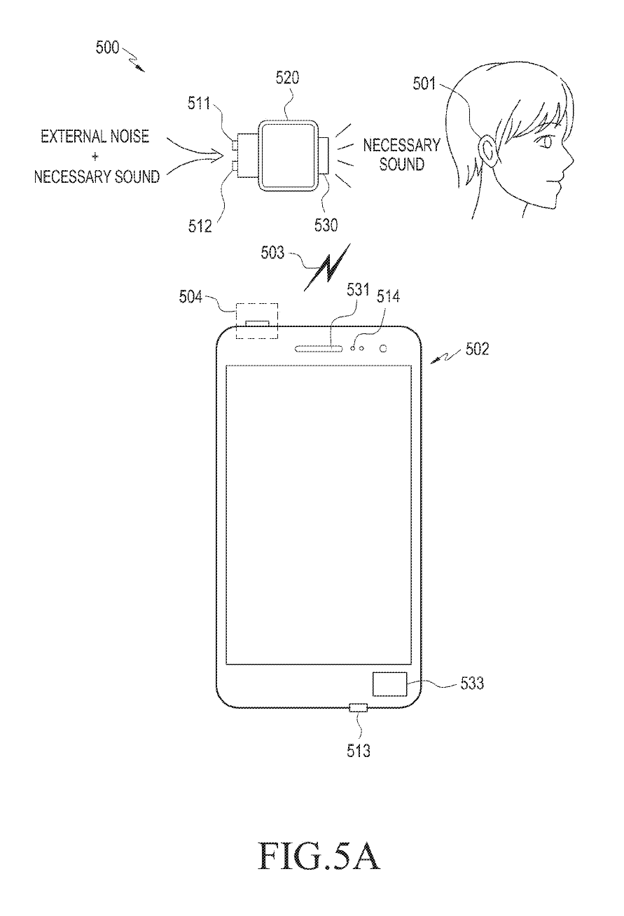

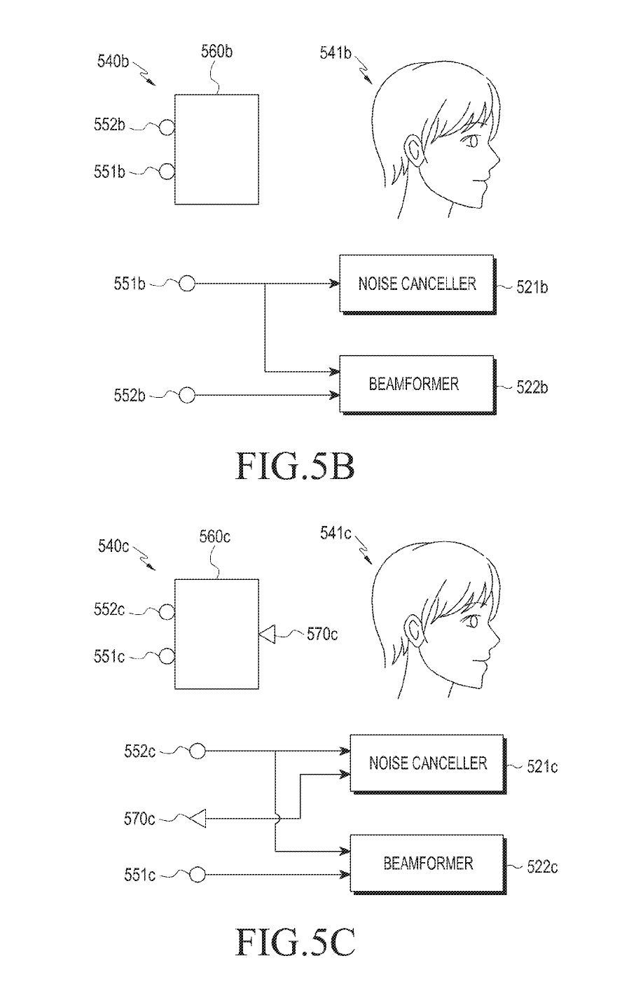

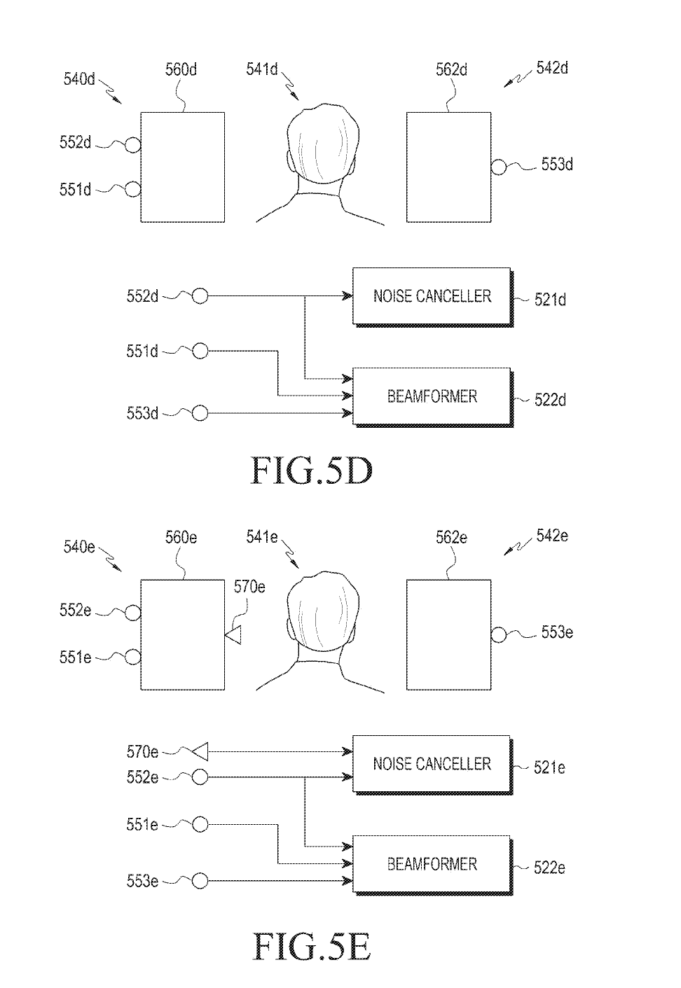

FIGS. 5A to 5E are diagrams illustrating use environments of an electronic device for cancelling noise according to embodiments of the present disclosure.

According to an embodiment of the present disclosure, as illustrated in FIG. 5A, an electronic device 500 may include a first microphone 511, a second microphone 512, a speaker 530, and a housing 520.

According to an embodiment of the present disclosure, an electronic device 502 may include a connector 504, microphones 513 and 514, and speakers 531 and 533.

According to an embodiment of the present disclosure, the electronic device may be connected to the electronic device 502 through wired communication 503 through a communication unit (e.g., the communication module 220 and the interface 270) included in the electronic device 500. The electronic device may be connected to the electronic device 502 through a connector 504 corresponding to the communication unit. The electronic device 502 (e.g., a processor included in the electronic device 502) can control the electronic device 500 to output some audio signals (e.g., a necessary signal) on the basis of the sound receiving condition and cancel the some other audio signals (e.g., noise signals).

According to an embodiment of the present disclosure, the electronic device 500 (e.g., the processor included in the electronic device 500) can output some audio signals, and cancel the some other audio signals on the basis of the sound receiving condition. The electronic device 502 can provide information corresponding to the audio signals output from the electronic device 500 or the audio signals canceled by the electronic device 500 (e.g., display the information on a display). For example, when the electronic device 500 outputs sounds of a vehicle on the right side of the electronic device 500, the electronic device 502 can output information indicating that “a vehicle exists on the right side” through the display included in the electronic device 502.

According to an embodiment of the present disclosure, the first microphone 511 and the second microphone 512 may be located to be spaced apart from the electronic device 500 by a predetermined distance. The first microphone 511 and the second microphone 512 may be exposed to the outside to receive external sounds the electronic device.

According to an embodiment of the present disclosure, the electronic device 500 may include two or more microphones, and the number of microphones is not limited thereto.

According to an embodiment of the present disclosure, the housing 520 may include a structure which can be worn on ears 501 of a user in order to allow the speaker 503 to come into contact with the ears 501 of the user.

According to an embodiment of the present disclosure, the speaker 503 can provide some sounds (necessary sounds) obtained by cancelling noise from external sounds through the electronic device 500. For example, the speaker 530 can be set to output the necessary signal selected through the electronic device 500 and a reverse phase signal of a signal obtained by cancelling the necessary signal from the external sounds, and cancel noise except for the necessary signal from among the external sounds entering between the ears 501 of the user and the speaker 530.

According to an embodiment of the present disclosure, as illustrated in FIG. 5B, an electronic device 540b may include a housing 560b, a first microphone 551b, and a second microphone 552b. For example, the first microphone 551b and the second microphone 552b may be exposed to the outer surface of the housing 560b. For example, a noise canceller 521b of the electronic device can obtain external audio signals from one microphone of the first microphone 551b and the second microphone 552b. For example, the noise canceller 521b can generate a reverse phase signal of the signal except for the necessary signal among the external audio signals obtained from the one microphone. For example, a beamformer 522b can obtain external audio signals from the first microphone 551b and the second microphone 552b. For example, the beamformer 552b can obtain a necessary signal obtained from a beamforming direction among the external audio signals, using two microphones.

According to an embodiment of the present disclosure, as illustrated in FIG. 5C, an electronic device 540c may include a housing 560c, a first microphone 551c, a second microphone 552c, and an error detecting microphone 570c. For example, the error detecting microphone 570c may be located on the inner surface of the housing, which is inserted into an ear 541c of the user, among surfaces of the housing 560c. For example, the first microphone 551c and the second microphone 552c may be located on an outer surface which is a surface opposite to the inner surface of the housing. For example, the error detecting microphone 570c can detect an output signal output to the ear 541c of the user by the speaker 530 located on the inner surface of the housing. For example, a noise canceller 521c of the electronic device can acquire, through the first microphone 551c and the second microphone 552c, external audio signals obtained from the outside of the electronic device, and acquire, through the error detecting microphone 570c, output signals output to the ear 541c of the user by the speaker 530 located on the inner surface of the housing. For example, the noise canceller 521c can generate a reverse phase signal of a signal except for the necessary signal among the external audio signals obtained through the first microphone 551c and the second microphone 552c. For example, the noise canceller 521c can compare a signal output through the speaker 530 located on the inner surface of the housing 560c with the necessary signal, and correct an error between the necessary signal and the output signal according to a result of the comparison. For example, a beamformer 522c can obtain a necessary signal obtained from a beamforming direction among the external audio signals through the first microphone 551b and the second microphone 552b.

According to an embodiment of the present disclosure, as illustrated in FIG. 5D, an electronic device 540d and an electronic device 542d can be inserted into both ears of a user 541d. For example, the electronic device 540d may include a first microphone 551d, a second microphone 552d, and a housing 560d. For example, the electronic device 542d may include a third microphone 553d. As illustrated in FIG. 5D, the first microphone 551d, the second microphone 552d, and the third microphone 553d may be exposed to the outside of the housings (the housing 560d and the housing 562d) of the electronic devices (the electronic device 540d and the electronic device 542d). For example, the noise canceller 521d can generate a reverse phase signal by obtaining audio signals from the second microphone 552d. For example, a beamformer 522d can obtain external audio signals through the first microphone 551d, the second microphone 552d, and the third microphone 553d, so as to select the necessary signal.

According to an embodiment of the present disclosure, as illustrated in FIG. 5E, an electronic device 540e and an electronic device 542e can be inserted into both ears of a user 541e, and the electronic device 540e may include a first microphone 551e, a second microphone 552e, a housing 560e, and an error detecting microphone 570e, and the electronic device 542e may include a third microphone 553e. For example, a noise canceller 521e can obtain an audio signal from the second microphone 552e so as to generate a reverse phase signal, obtain an output signal output through the speaker 530 through the error detecting microphone 570e, and correct an error between the obtained output signal and the necessary signal.

In the above embodiment of the present disclosure, as illustrated in FIGS. 5B and 5D, a case where the error detecting microphone is not provided may be defined as a method of cancelling noise in a feed-forward scheme. In connection with the method of cancelling noise in the feed-forward scheme, for example, the noise canceller can store a compensation value for an error for preparing a state in which a user twistedly wears the electronic device and a state in which the electronic device is worn incorrectly. In case of the method of cancelling noise in the feed-forward scheme, a separate error detecting microphone on a surface in contact with ears of a user may be not needed.

In contrast, as illustrated in FIGS. 5C and 5E, a case where the error detecting microphone is provided may be defined as a method of cancelling noise in a feedback scheme. In order to generate a reverse phase signal of a sound entering ears 541c and 541e of the user, the error detecting microphone may be provided on the inner surface of the electronic devices 540c and 540e, and can detect the sound entering the ears 541c and 541e of the user while being provided on the inner surface.

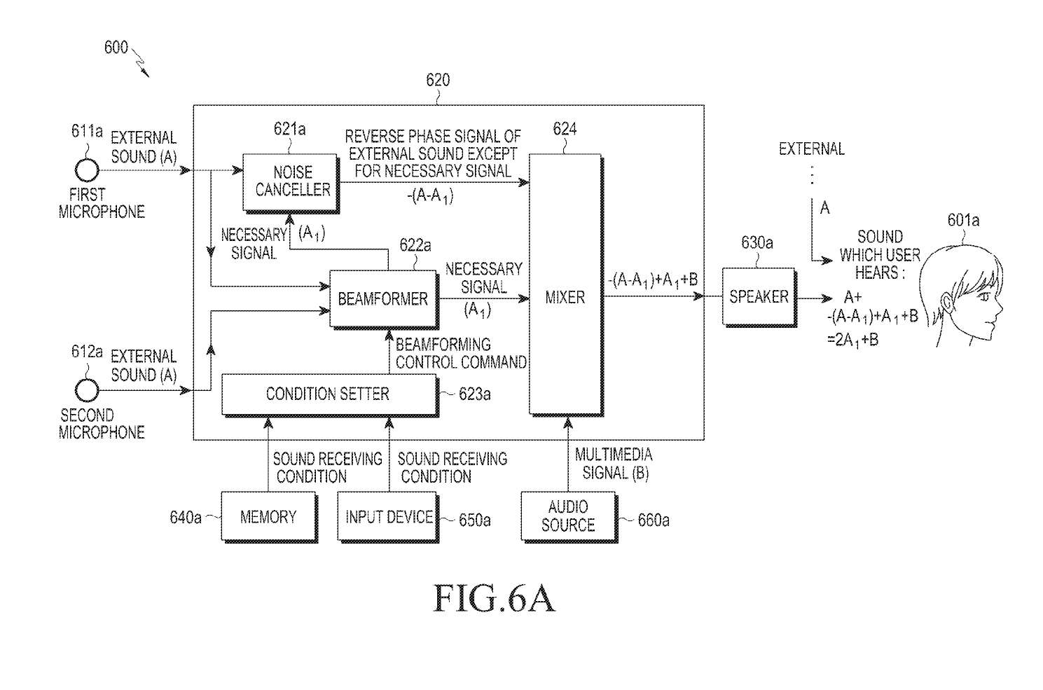

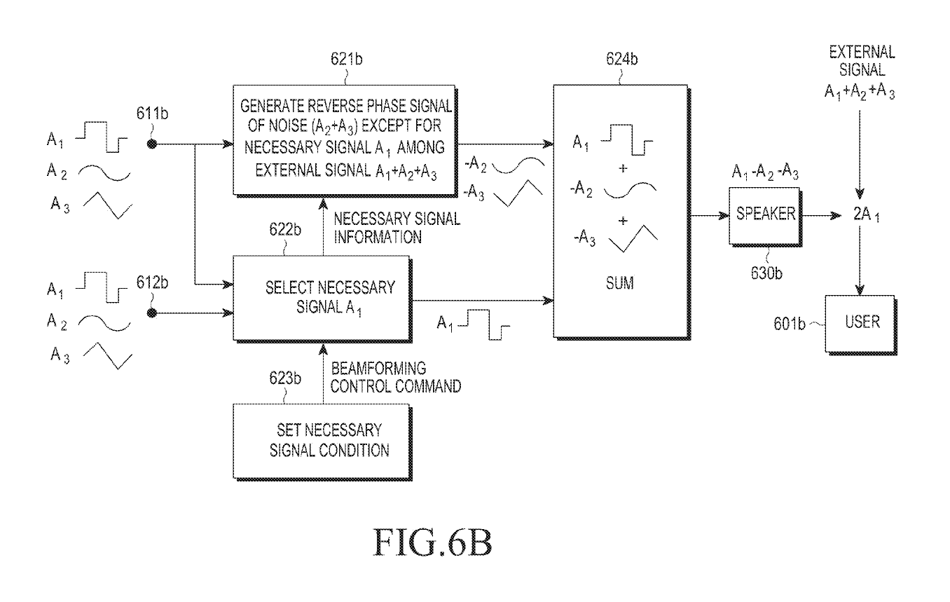

FIGS. 6A and 6B are block diagrams illustrating an electronic device according to embodiments of the present disclosure.

According to an embodiment of the present disclosure, referring to FIG. 6A, an electronic device 600 may include a plurality of microphones 611a and 612a, a processor 620a, a speaker 630a, a memory 640a, an input device 650a, and an audio source 660a.

Although not illustrated, according to an embodiment of the present disclosure, at least some of the plurality of microphones 611a and 612a, the processor 620a, the speaker 630a, the memory 640a, and the input device 650a may be included in another electronic device. For example, the plurality of microphones 611a and 612a, the processor 620a, and the speaker 630a may be included in the electronic device (e.g., an earphone), and the memory 640a, the input device 650a, and the audio source 660a may be included in the another electronic device (e.g., a smartphone). Further, for example, the first microphone 611a, a noise canceller 621a, a beamformer 622a, a mixer 624a, and the audio source 660a may be included in the electronic device, and the second microphone 612a, a condition setter 623a, the memory 640a, the input device 650a, and the speaker 630a may be included in the another electronic device. Various embodiments of the present disclosure are not limited thereto.

According to an embodiment of the present disclosure, the first microphone 611a and the second microphone 612a can receive external sounds (A or external audio signals) of the electronic device. The received external sounds A may be transmitted to the noise canceller 621a and the beamformer 622a. The external sounds may include, for example, noise and a necessary signal.

According to an embodiment of the present disclosure, when the external signals A are received from the plurality of microphones 611a and 612a, the beamformer 622a can detect a signal received in a specific direction or a signal having a specific waveform among the received external sounds A, as a necessary signal A₁, on the basis of a beamforming control command from the condition setter 623a. The detected necessary signal A₁ may be transmitted to the mixer 624.

According to an embodiment of the present disclosure, when the external sounds A are received from the plurality of microphones 611a and 612a, the noise canceller 621a can detect noise signals A-A₁ among the external sounds A on the basis of the necessary signal A₁ detected by the beamformer 622a. For example, the noise canceller 621a can generate a reverse phase signal −(A-A₁) of the detected noise signal A-A₁, and transmit the reverse phase signal of the received noise signal to the mixer 624a. This may be an example of a method of cancelling a noise signal among external sounds.

According to an embodiment of the present disclosure, the condition setter 623a can generate a beamforming control command on the basis of sound receiving condition data stored in the memory 640a and a sound receiving condition input received through the input device 650a. The generated beamforming control command can be transmitted to the beamformer 622a.

According to an embodiment of the present disclosure, the audio source 660a can generate a multimedia signal B and transmit the generated multimedia signal B to the mixer 624A.

According to an embodiment of the present disclosure the mixer 624A can mix the reverse phase signal −(A-A₁) transmitted from the noise canceller 621a, the necessary signal A1 transmitted from the beamformer 622a, and the multimedia signal B transmitted from the audio source 660a, and output the mixed signal to the speaker 630a.

According to an embodiment of the present disclosure, the speaker 630a can output the mixed signal −(A-A₁)+A₁+B output from the mixer 624A, to ears 601 of the user. For example, when the mixed signal −(A-A₁)+A₁+B is output by the speaker 630a and the external sounds enter ears of the user, the mixed signal −(A-A₁)+A₁+B and the external sounds A are mixed so that only the multimedia signal B and the necessary signal 2A₁ reach the ears 601a of the user.

According to an embodiment of the present disclosure, as illustrated in FIG. 6B, a first microphone 611b and a second microphone 612b can obtain an external signal A₁+A₂+A₃, and transmit the obtained external signal A₁+A₂+A₃ to the beamformer 622b and the noise canceller 621b.

For example, the condition setter 623b can set a sound receiving condition for a necessary signal in response to the sound receiving condition or the sound receiving condition input obtained from the input device 650a and the memory 640a, and transmit a beamforming control command including the sound receiving condition for the necessary signal to the beamformer 622b.

For example, the beamformer 622b can detect (or determine) the necessary signal A₁ among the external signal A₁+A₂+A₃ obtained through the first microphone 611b and the second microphone 612b on the basis of the sound receiving condition for the necessary signal. The beamformer 622b can transmit the detected necessary signal A₁ to the noise canceller 621b.

For example, the noise canceller 621b can generate a reverse phase signal −(A₁+A₂+A₃) of the obtained external signal A₁+A₂+A₃, add the reverse phase signal −(A₁+A₂+A₃) to the necessary signal A₁ to generate a reverse phase signal −(A₂+A₃) of noise excluding the necessary signal, and transmit the generated reverse phase signal −(A₂+A₃) to the mixer 624b.

The mixer 624b can transmit a signal A₁-(A₂+A₃) obtained by adding the reverse phase signal −(A₂+A₃) of noise to the necessary signal A₁, to the speaker 630b.

As a result, the user 601b can obtain the necessary signal 2A₁ obtained by cancelling a noise signal A₂+A₃ excluding the necessary signal from the external signal A₁+A₂+A₃ entering between the speaker 630b and ears of the user from the outside.

According to an embodiment of the present disclosure, the first microphone 611a, the second microphone 612a, the processor 620, the speaker 630a, the memory 640a, the input device 650a, and the audio source 660a may be included in one device (e.g., the electronic device 500) or a plurality of devices (e.g., the electronic device 500 and the electronic device 502).

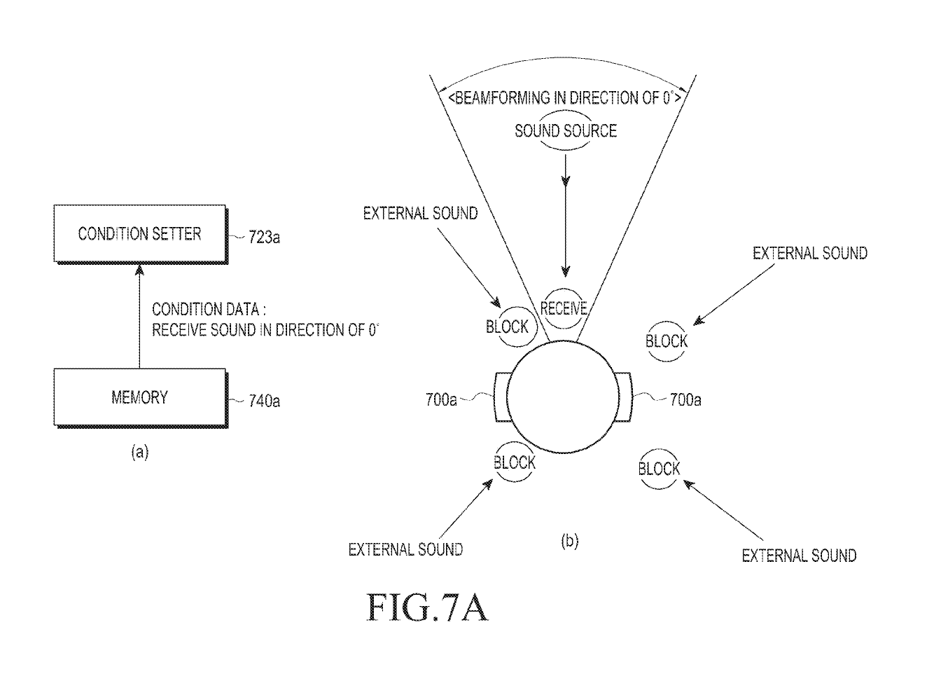

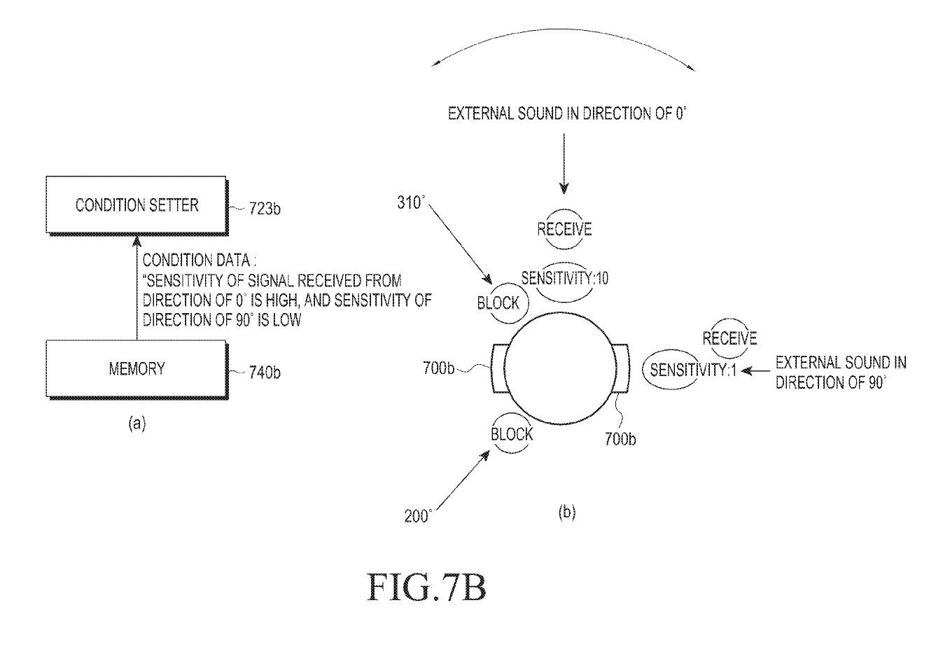

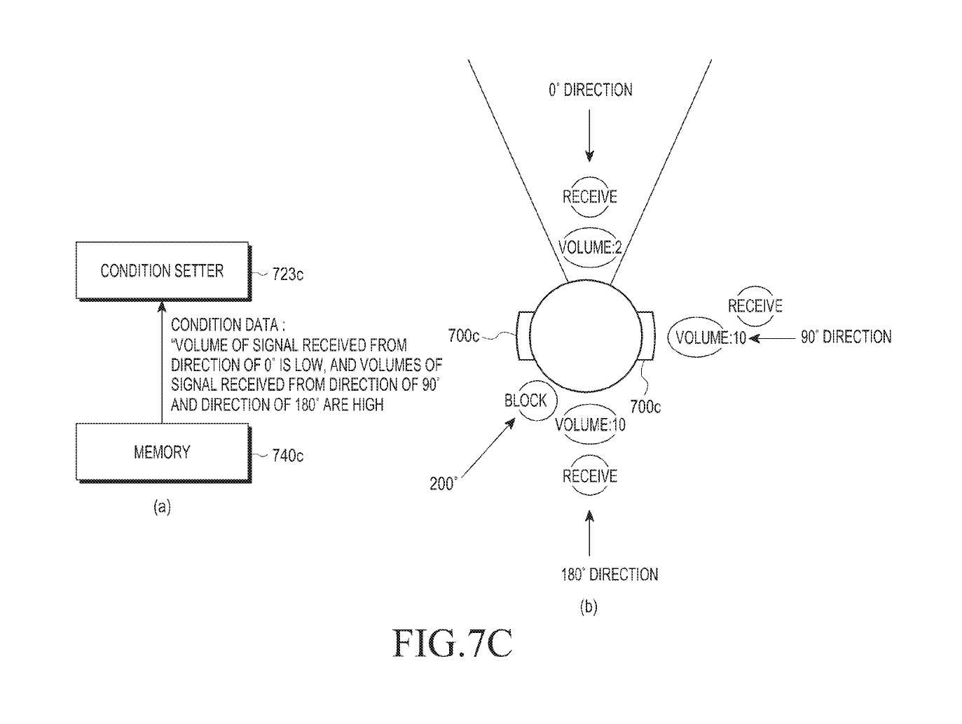

FIG. 7A is a diagram illustrating an example of a method of cancelling noise according to embodiments of the present disclosure.

According to an embodiment of the present disclosure, referring to FIG. 7A(a), a condition setter 723a can obtain a sound receiving condition for a necessary signal, which has a content of “receive sound in direction of 0 degrees”, from a memory 740a. For example, the condition setter 723a can obtain the sound receiving condition of “receive sound in direction of 0 degrees”, and transmit, to a beamformer, a beamforming control command for setting a beamforming direction or region to receive sound in a direction or region of 0 degrees on the basis of the obtained sound receiving condition of “receive sound in direction of 0 degrees”.

Referring to FIG. 7A(b), an electronic device 700a is worn on both ears of a user. According to an embodiment of the present disclosure, as illustrated in FIG. 7A(a), the electronic device 700a can set a beamforming direction or region as the predetermined direction or region of 0 degree on the basis of the sound receiving condition of “receive sound in direction of 0 degrees”. Accordingly, the electronic device 700a can cancel a noise signal not corresponding to the direction or region of 0 degrees among a plurality of external sounds. Further, the electronic device 700a can receive a signal received from a “sound source” direction or region of 0 degrees, as a necessary signal. Meanwhile, an angle or range of the beamforming direction or region may be changed.

FIG. 7B is a diagram illustrating an example of a method of cancelling noise according to embodiments of the present disclosure.

According to an embodiment of the present disclosure, as illustrated in FIG. 7B(a), a condition setter 723b can set the predetermined beamforming region of 0 degrees to have high sensitivity (e.g., the sensitivity: 10) and set a beamforming region of 90 degrees to have low sensitivity (e.g., the sensitivity: 1) on the basis of a sound receiving condition of “receive direction of 0 degrees to be high and direction of 90 degrees to be low”, obtained from a memory 740b. Accordingly, as illustrated in FIG. 7B(b), an electronic device 700b can cancel a noise signal not corresponding to the direction of 0 degrees or the direction of 90 degrees from a plurality of external sounds. Further, the electronic device 700b can receive external sound, received from the direction of 0 degrees, as a necessary signal at “the sensitivity: 10”, and receive external sound, received from the direction of 90 degrees, as a necessary signal at “the sensitivity: 1”.

FIG. 7C is a diagram illustrating an example of a method of cancelling noise according to embodiments of the present disclosure.

According to an embodiment of the present disclosure, as illustrated in FIG. 7C(a), a condition setter 723c can set the predetermined beamforming region of 0 degree to have a low volume of received sounds (e.g., the volume: 2) and set a beamforming region of 90 degrees and a beamforming region of 180 degrees to have high volumes of received sound (e.g., volume sensitivity: 10) on the basis of a sound receiving condition of “receive direction of 0 degrees to be low and direction of 90 degrees and direction of 180 degrees to be high”, obtained from a memory 740c. Accordingly, as illustrated in FIG. 7C(b), an electronic device 700c can cancel a noise signal not corresponding to the direction of 0 degrees, the direction of 90 degrees, or the direction of 180 degrees from a plurality of external sounds. Further, the electronic device 700c can receive external sounds from the direction of 0 degrees to output the external sounds to have the size of “a volume: 2”, and receive external sounds from the directions of 90 degrees and 180 degrees to output the external sounds as a necessary signal to have the size of “a volume: 10”.

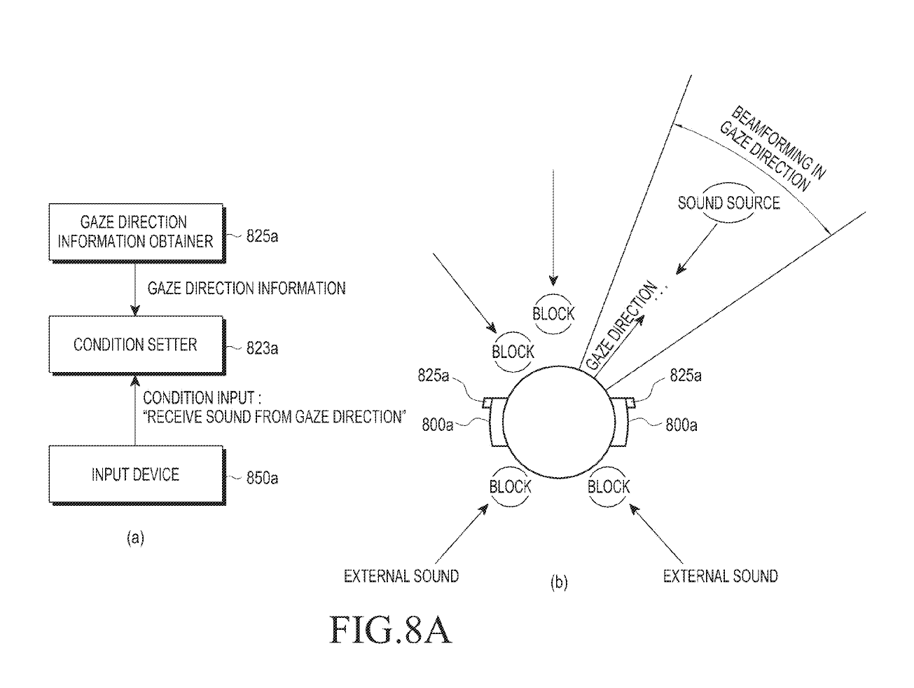

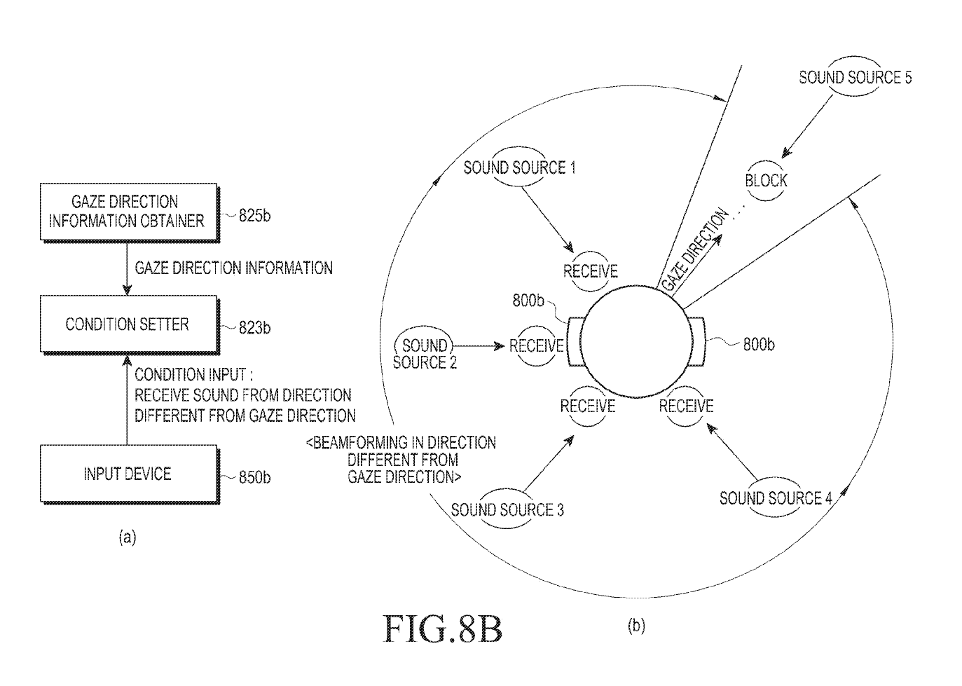

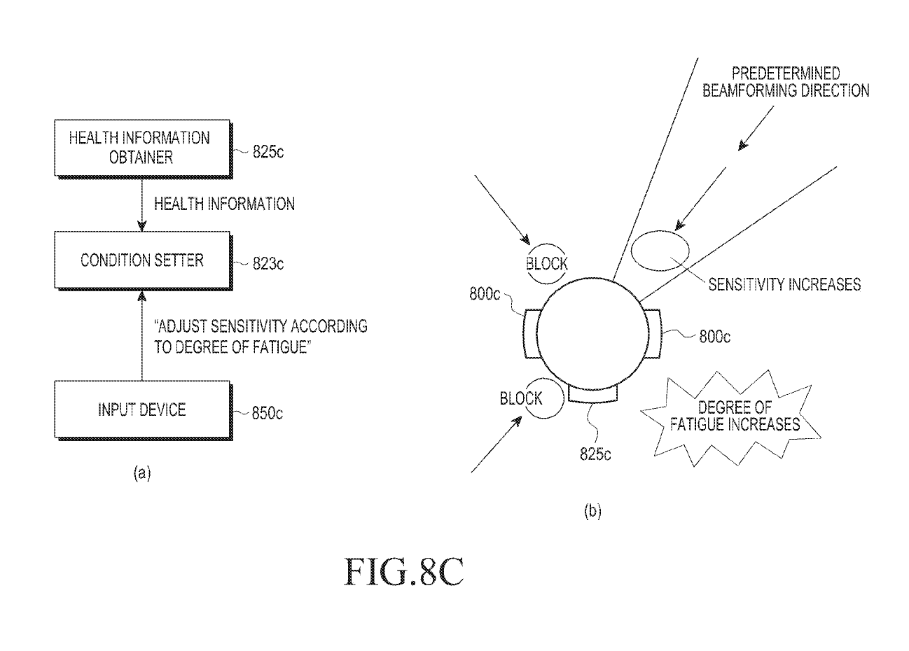

FIG. 8A is a diagram illustrating an example of a method of cancelling noise according to embodiments of the present disclosure.

According to an embodiment of the present disclosure, referring to FIG. 8A(a), a condition setter 823a can obtain a sound receiving condition for a necessary signal, which has a content of “receive sound in gaze direction” and is input through the input device 850a, as an example of sound receiving conditions. The condition setter 823a can transmit a request signal for gaze direction information of a user to a gaze direction information obtainer 825a according to the obtained sound receiving condition of “receive sound in gaze direction”, the gaze direction information obtainer 825a can detect image information of eyes of the body of a user in response to the request signal, and generate gaze direction information of the user on the basis of the detected image information of eyes, and the condition setter 823a can obtain the gaze direction information of the user, which is generated by the gaze direction information obtainer 825a.

According to an embodiment of the present disclosure, referring to FIG. 8A(b), the condition setter 823a can set a beamforming direction or a beamforming region in a gaze direction of a user. An electronic device 800a can cancel all noise not corresponding to a gaze direction or region of the user among a plurality of external sounds. Further, the electronic device 800a can receive only a sound signal received from a sound source of the gaze direction or region, as a necessary signal.

FIG. 8B is a diagram illustrating an example of a method of cancelling noise according to embodiments of the present disclosure.

According to an embodiment of the present disclosure, referring to FIG. 8B(a), a condition setter 823b can obtain a sound receiving condition for a necessary signal, which has a content of “receive sound in direction different from gaze direction” and is input through the input device 850b.

According to an embodiment of the present disclosure, referring to FIG. 8B(b), the condition setter 823b can set a beamforming direction or a beamforming region in a direction different from the gaze direction of a user. An electronic device 800b can cancel all noise not corresponding to a gaze direction or region different from the gaze direction or region of the user among a plurality of external sounds. Further, the electronic device 800a can receive only a sound signal received from a sound source of a gaze direction or region different from the gaze direction or region, as a necessary signal.

FIG. 8C is a diagram illustrating an example of a method of cancelling noise according to embodiments of the present disclosure.

According to an embodiment of the present disclosure, referring to FIG. 8C(a), a condition setter 823c can obtain a sound receiving condition for a necessary signal, which is to “adjust sensitivity of beamforming according to a degree of fatigue of user” and is input through the input device 850c, as an example of sound receiving conditions. The condition setter 823c can transmit a request signal for health information of a user to a health information obtainer 825c provided outside an electronic device 800c according to the sound receiving condition of “adjust sensitivity of beamforming according to a degree of fatigue of user”, the health information obtainer 825c can detect body information of the user while being in contact with the body of the user, in response to the request signal, and generate user health information on the basis of the detected body information, and the condition setter 823c can obtain user health information generated by the health information obtainer 825c in response to the request signal.

For example, as illustrated in FIG. 8C(b), the condition setter 823c can adjust the sensitivity of a predetermined beamforming direction according to a degree of fatigue of a user. The electronic device 800c can cancel all noise not corresponding to a predetermined beamforming direction among a plurality of external sounds. Further, while receiving a sound signal received from a sound source of the predetermined beamforming direction as a necessary signal, the electronic device 800c can adjust (for example, increase) the sensitivity for beamforming in a predetermined direction on the basis of health information of “degree of fatigue increases” obtained by the health information obtainer 825c.

According to an embodiment of the present disclosure, although not illustrated in FIG. 8, the electronic device may further include a motion detecting sensor. Further, when a command “to receive signal in direction corresponding to motion of user” is received through the input device, the condition setter can control the beamformer to detect a signal in a direction corresponding to the motion of a user (or a signal in a direction not corresponding to the motion of a user) on the basis of motion information of a user. For example, when it is detected through the motion detecting sensor that a motion direction of the user is an eastern direction, the condition setter can control the beamformer to detect a signal in a western direction opposite to the eastern direction.

According to an embodiment of the present disclosure, although not illustrated in FIG. 8, the electronic device may further include a location detecting sensor (for example, GPS, Wi-Fi, and the like). Further, when a command “to receive signal in direction corresponding to location of user” is received through the input device, the condition setter can control the beamformer to detect a signal in a direction corresponding to the location of a user (or a signal in a direction not corresponding to the location of a user) on the basis of location information of a user. For example, when it is detected through the location detecting module that the location of a user is “a school”, the condition setter can control the beamformer to detect a direction in the forward direction of the user (or in the front direction of a classroom of the school). For example, when it is detected through the location detecting module that the location of a user is “a road”, the condition setter can control the beamformer to detect only a signal including a signal waveform corresponding to a sound of a vehicle (for example, a horn sound of the vehicle).

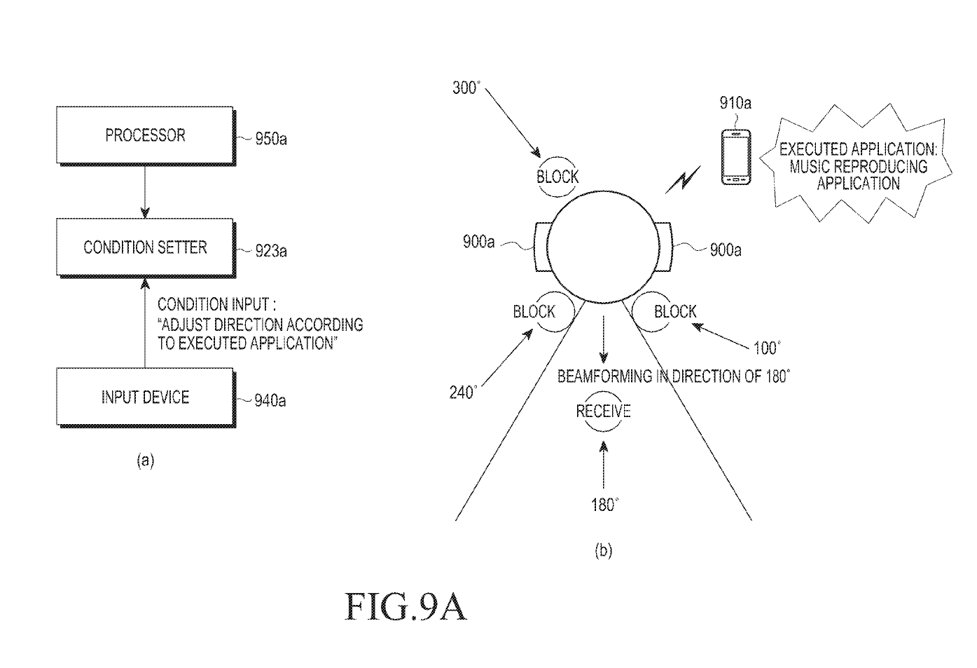

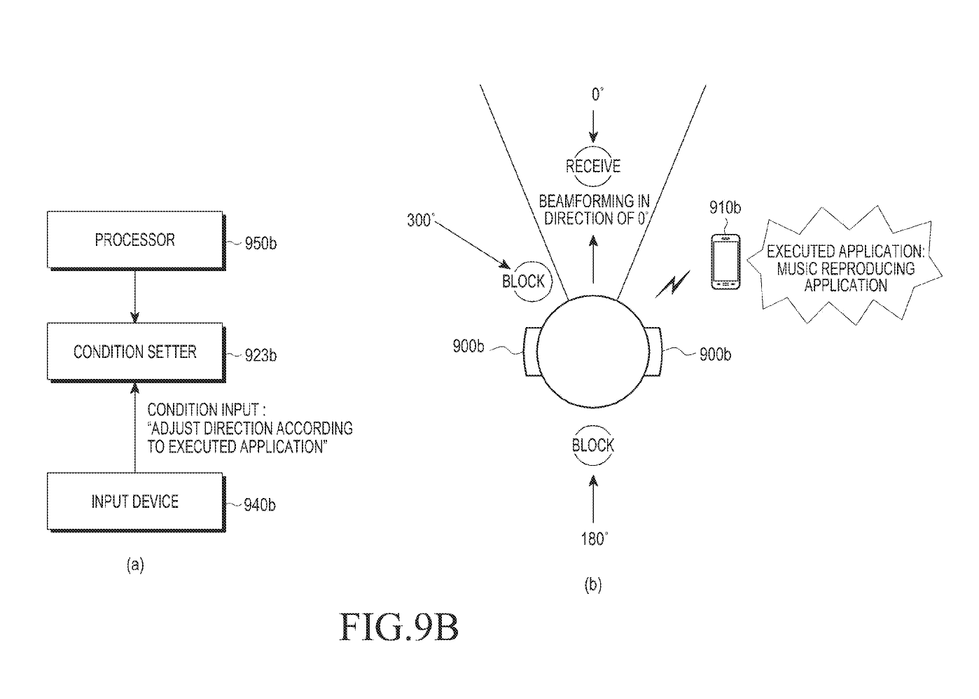

FIG. 9A is a diagram illustrating an example of a method of cancelling noise according to embodiments of the present disclosure.

According to an embodiment of the present disclosure, referring to FIG. 9A(a), a condition setter 923a can obtain a sound receiving condition for a necessary signal, which has a content of “adjust direction according to executed application” from an input device 940a. For example, the condition setter 923a can obtain a sound receiving condition of “adjust direction according to executed application”, and transmit a beamforming control command to set a beamforming direction or a beamforming region, to the beamformer, on the basis of the obtained sound receiving condition of “adjust direction according to executed application” and execution application information received from a processor 950a.

For example, as illustrated in FIG. 9A(b), the condition setter 923a can obtain the sound receiving condition of “adjust direction according to execution application” and information indicating that an application executed by a current electronic device 910a from the processor 950a is “a music reproducing application”, and can set a beamforming direction or region to a direction or region of 180 degrees on the basis of the obtained sound receiving condition and the obtained information. For example, the electronic device 900a can cancel an external sound of a direction or region of 100 degrees, an external sound of a direction or region of 240 degrees, and an external sound of a direction or region of 300 degrees among a plurality of external sounds. Further, the electronic device 900a can receive an external signal received from the direction or region of 180 degrees, as a necessary signal.

FIG. 9B is a diagram illustrating an example of a method of cancelling noise according to embodiments of the present disclosure.

As illustrated in FIG. 9B(a) and FIG. 9B(b), a condition setter 923b can obtain the sound receiving condition of “adjust direction according to execution application” and information indicating that an application executed by a current electronic device 910b from the processor 950b is “a video reproducing application”, from the input device 940b, and can set a beamforming direction or region to a direction or region of 0 degrees on the basis of the obtained sound receiving condition and the obtained information. For example, an electronic device 900b can cancel the external sound in the direction or region of 180 degrees and the external sound in the direction or region of 300 degrees among the plurality of external sounds. Further, the electronic device 900b can receive an external signal received from the direction or region of 0 degrees, as a necessary signal.

Although not illustrated in FIG. 9, when a game application is executed in the electronic device, the condition setter can control the beamformer to detect only a signal corresponding to a voice pattern of a neighboring person outside the electronic device (for example, signal corresponding to pre-stored first voice pattern).

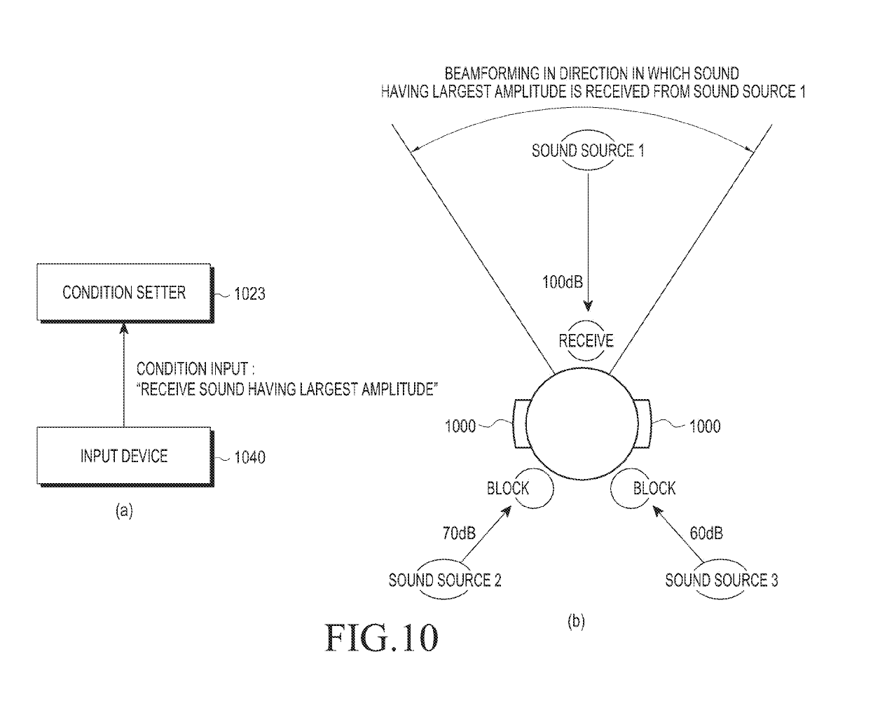

FIG. 10 is a diagram illustrating an example of a method of cancelling noise according to embodiments of the present disclosure.

According to an embodiment of the present disclosure, referring to FIG. 10(a), a condition setter 1023 can receive an input of “receive largest reception sound” which is a sound receiving condition input received through an input device 1040.

According to an embodiment of the present disclosure, referring to FIG. 10(b), the condition setter 1023 can set a beamforming direction or region as a direction or region from which the largest reception sound (sound received from sound source 1, the size of the sound is 100 dB) is received among external sounds received from sound source 1, sound source 2, and sound source 3 to an electronic device according to the input “receive largest reception sound”. When the beamforming direction or region is configured to be a direction of “the sound source 1” from which the largest sound among a plurality of sound sources is received, an electronic device 1000 can cancel all noise signals among external sounds, output sounds received from a direction or region of “the sound source 1” among the external sounds to ears of a user, and cancel all sounds received from a direction or region of the other “sound source 2” and the other “sound source 3”.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter.

According to embodiments of the present disclosure, at least some of the devices (for example, modules or functions thereof) or the method (for example, operations) according to the present disclosure may be implemented by a command stored in a computer-readable storage medium in a programming module form. The instruction, when executed by a processor (e.g., the processor 120), may cause the one or more processors to execute the function corresponding to the instruction. The computer-readable storage medium may be, for example, the memory 130.

The computer readable recoding medium may include a hard disk, a floppy disk, magnetic media (e.g., a magnetic tape), optical media (e.g., a Compact Disc Read Only Memory (CD-ROM) and a Digital Versatile Disc (DVD)), magneto-optical media (e.g., a floptical disk), a hardware device (e.g., a Read Only Memory (ROM), a Random Access Memory (RAM), a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

In accordance with embodiments of the present disclosure, sounds having high quality can be provided to a user while a shielding performance is maintained when a noise removal function of an electronic device is canceled, and sounds which the user needs, e.g., only sounds from a direction wanted by the user among surrounding external sounds can be provided to the user, thereby ensuring safe walking and convenience of the user.

Further, in accordance with embodiments of the present disclosure, a notification of an emergency situation, which is received from a direction different from a gaze direction of a user and which a user cannot hear when wearing headphones or earphones, can be provided to the user through the headphones or the earphones of the user, thereby more rapidly notifying of an emergency situation outside of the gaze direction of the user.

Further, in accordance with embodiments of the present disclosure, a speech of a speaker coinciding with the gaze direction of a user can provided to the user through headphones or earphones, thereby improving a convenience of hearing external sounds for the user.

The programming module according to the present disclosure may include one or more of the aforementioned components or may further include other additional components, or some of the aforementioned components may be omitted. Operations executed by a module, a programming module, or other component elements according to embodiments of the present disclosure may be executed sequentially, in parallel, repeatedly, or in a heuristic manner. Further, some operations may be executed according to another order or may be omitted, or other operations may be added. Various embodiments disclosed herein are provided merely to easily describe technical details of the present disclosure and to help the understanding of the present disclosure, and are not intended to limit the scope of the present disclosure.

While the present disclosure has been shown and described with reference to an embodiment thereof, it will be understood by those skilled in the art that various changes in form and details may be made therein without departing from the spirit and scope of the disclosure as defined by the appended claims and their equivalents.

What is claimed is:

1. An electronic device of cancelling noise using a plurality of microphones, the electronic device comprising:
a plurality of microphones configured to obtain audio signals;
a beamformer configured to provide, through a speaker, at least two audio signals selected on a basis of at least one of user information, external environment information, and information on an application executed the electronic device, among the obtained audio signals; and
a noise canceller configured to cancel at least some of the other audio signals determined on the basis of at least some of the selected audio signals, among the obtained audio signals.

2. The electronic device of claim 1, wherein the noise canceller generates reverse phase signals of at least one of the other audio signals.

3. The electronic device of claim 2, further comprising a mixer configured to output signals obtained by mixing the reverse phase signal and the at least two selected audio signals, to the speaker.

4. The electronic device of claim 1, further comprising a condition setter configured to obtain at least one piece of information among the user information, the external environment information, and the information on an application executed by the electronic device, and control the beamformer on the basis of the obtained at least one piece of information.

5. The electronic device of claim 4, wherein the condition setter cancels at least one piece of information of the user information, the external environment information, and the information on an application executed by the electronic device, on a basis of a predetermined sound receiving condition.

6. The electronic device of claim 1, wherein the user information includes at least one piece of information of user health information, user location information, and user gaze direction information.

7. The electronic device of claim 1, wherein the external environment information includes at least one piece of information among information on a sound receiving direction of at least some of the audio signals, information on a sound receiving sensitivity, and information on a sound receiving size.

8. The electronic device of claim 1, wherein the execution application information includes information on a content of an application executed by the electronic device.

9. The electronic device of claim 1, further comprises a communication unit configured to communicate with an external electronic device,
wherein the communication unit receives, from the external electronic device, a signal for selecting audio signals to be output through the speaker, and a control signal for cancelling at least one other audio signal among the audio signals.

10. The electronic device of claim 1, further comprising:
a housing wearable on ears of a user; and
an error detecting microphone for detecting an output signal output through the speaker, the error detecting microphone being located in a first surface of the housing, which is inserted into ears of a user, when the housing is worn on the ears of the user,
wherein the noise canceller is further configured to correct an error between the output signal and the at least selected some audio signals.

11. A method of cancelling noise using a plurality of microphones, the method comprising:
obtaining audio signals;
providing, to a speaker, at least two audio signals, selected on a basis of at least one piece of information of user information, external environment information, and information on an executed application, among the obtained audio signals; and
cancelling at least one of the other audio signals determined on the basis of at least some of the selected audio signals among the obtained audio signals.

12. The method of claim 11, further comprising generating reverse phase signals of at least some of the other audio signals.

13. The method of claim 12, further comprising:
mixing the reverse phase signal and at least some of the selected audio signals; and
outputting the mixed audio signal to the speaker.

14. The method of claim 13, further comprising outputting a multimedia signal to the speaker.

15. The method of claim 11, wherein the user information includes at least one piece of information of user health information and user gaze direction information.

16. The method of claim 11, wherein the external environment information includes at least one piece of information among information on a sound receiving direction of at least some of the audio signals, information on a sound receiving sensitivity, and information on a sound receiving size.

17. The method of claim 11, wherein the execution application information includes information on a content of an application.

18. The method of claim 11, further comprising:
receiving a signal for selecting some audio signals to be output through the speaker; and
receiving, from the external electronic device, a control signal for cancelling some of the other audio signals among the audio signals.

19. An electronic device of cancelling noise using an external electronic device, the electronic device comprising:
a communication unit configured to communicate with an external electronic device; and
a processor functionally connected to an external electronic device,
wherein the processor is configured to transmit a signal for selecting at least two audio signals to be output through the external electronic device on a basis of at least one piece of information of user information, external environment information, and information on an application executed by the electronic device, among audio signals obtained through the external electronic device, and
transmit, to the external electronic device, a signal for cancelling at least one other audio signal among the audio signals.

20. The electronic device of claim 19, wherein the user information includes at least one piece of information of user health information, user location information, and user gaze direction information,
the external environment information includes at least one piece of information among information on a sound receiving direction of at least some of the audio signals, information on a sound receiving sensitivity, and information on a sound receiving size, and the execution application information includes information on a content of an application executed by the electronic device.
